(19) United States
(12) Patent Application Publication
(10) Pub. No.: US 2005/0243165 A1
(43) Pub. Date: Nov. 3, 2005

(54) Methods and apparatuses for mapping locations

(76) Inventors: Sean Christopher Endler, San Francisco, CA (US); Joseph Steven Herres, Seattle, WA (US); Ippei Tambata, San Francisco, CA (US)

Correspondence Address: Valley Oak law;#106, 5655 Silver Creek Valley Road, San Jose, CA, 95138, US

(21) Appl. No.: 10/820,470

(22) Filed: Apr. 7, 2004

(51) Int. Cl. H04N 7/14

(52) U.S. Cl. 348/14.02; 348/14.01

(57) ABSTRACT

In one embodiment, the methods and apparatuses detect a plurality of participants; detect a location of each of the plurality of participants; identify a plurality of possible meeting locations based on a parameter; and select a meeting location from the plurality of possible meeting locations based on the location of each of the plurality of participants.

### FIELD OF THE INVENTION

The present invention relates generally to mapping locations and, more particularly, to mapping a meeting location between multiple locations.

### BACKGROUND

There has been a proliferation of portable electronic device utilized by both business and personal users. These portable electronic devices aid the user in tracking of their schedules, communicating with others via voice, and communicating with others via electronic messages. These portable electronic devices include cellular phones, personal digital assistants (PDAs), and the like.

For some users, these portable electronic devices are indispensable for organizing their calendars and communicating with others both for their professional and personal lives. For example, in some instances, the portable electronic device is used to set up a meeting between another person by communicating via either voice signals or electronic messages. In some instances, the portable electronic device is also used to store the meeting time and location on the user's calendar. In some instances, the portable electronic device also reminds the user of the scheduled meeting and directs the user to the meeting location based on the user's current location.

### SUMMARY

In one embodiment, the methods and apparatuses detect a plurality of participants; detect a location of each of the plurality of participants; identify a plurality of possible meeting locations based on a parameter; and select a meeting location from the plurality of possible meeting locations based on the location of each of the plurality of participants.

### BRIEF DESCRIPTION OF THE DRAWINGS

The accompanying drawings, which are incorporated in and constitute a part of this specification, illustrate and explain one embodiment of the methods and apparatuses for mapping locations. In the drawings,

FIG. 1 is a diagram illustrating an environment within which the methods and apparatuses for mapping locations are implemented;

FIG. 2 is a simplified block diagram illustrating one embodiment in which the methods and apparatuses for mapping locations are implemented;

FIG. 3 is a simplified block diagram illustrating a system, consistent with one embodiment of the methods and apparatuses for mapping locations;

FIG. 4 is an exemplary record for use with the methods and apparatuses for mapping locations;

FIG. 5 is an exemplary record for use with the methods and apparatuses for mapping locations;

FIG. 6 is a flow diagram consistent with one embodiment of the methods and apparatuses for mapping locations;

FIG. 7 is a flow diagram consistent with one embodiment of the methods and apparatuses for mapping locations;

FIG. 8 is a flow diagram consistent with one embodiment of the methods and apparatuses for mapping locations;

FIG. 9A is an exemplary screen shot consistent with one embodiment of the methods and apparatuses for mapping locations;

FIG. 9B is an exemplary screen shot consistent with one embodiment of the methods and apparatuses for mapping locations;

FIG. 10 is an exemplary screen shot consistent with one embodiment of the methods and apparatuses for mapping locations; and

FIG. 11 is an exemplary screen shot consistent with one embodiment of the methods and apparatuses for mapping locations.

### DETAILED DESCRIPTION

The following detailed description of the methods and apparatuses for mapping locations refers to the accompanying drawings. The detailed description is not intended to limit the methods and apparatuses for mapping locations. Instead, the scope of the methods and apparatuses for mapping locations are defined by the appended claims and equivalents. Those skilled in the art will recognize that many other implementations are possible, consistent with the present invention.

References to “device” include a device utilized by a user such as a computer, a portable computer, a personal digital assistant, a cellular telephone, and a device capable of receiving/transmitting an electronic message.

References to “meeting” or “event” refers to a gathering of more than one user or participant.

In one embodiment, the methods and apparatuses for mapping locations selects a meeting location based on a location of each of the two users. In one embodiment, the selected meeting location satisfies the amenity preferences of the users and is an agreeable physical location sited between the locations of the users. In another embodiment, a meeting location is selected for more than two users.

The methods and apparatuses for mapping locations are shown in the context of exemplary embodiments of applications in which selecting a group of possible meeting locations that fulfill the needs of the meeting participants. In one embodiment, these needs include general geographical area, date and time of the meeting, food and beverage preferences, activity preferences, and seating preferences. From this group of possible meeting locations, a meeting location is selected based on the locations of the participants in one embodiment. In another embodiment, the meeting location is selected also based on the mode of transportation utilized by each of the participants. In yet another embodiment, the meeting location is selected based on the time it takes all the participants to travel to the meeting location.

In one embodiment, the methods and apparatuses for mapping locations utilize a record associated with an identity of participant to track participant information such as the different modes of transportation available to each participant. In one embodiment, the methods and apparatuses for mapping locations utilize a record associated with an identity of a meeting location to track meeting location information such as hours of operation and the various amenities associated with the particular meeting location.

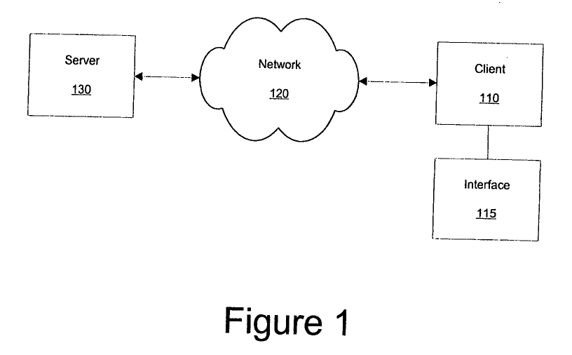

FIG. 1 is a diagram illustrating an environment within which the methods and apparatuses for mapping locations are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of mapping locations below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

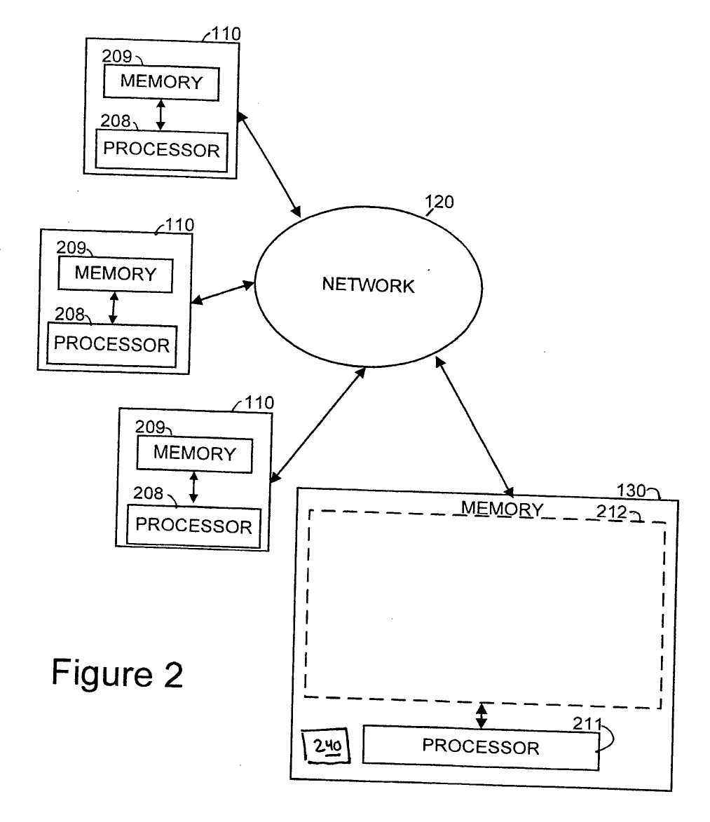

FIG. 2 is a simplified diagram illustrating an exemplary architecture in which the methods and apparatuses for mapping locations are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 110 and the server 130 include instructions for a customized application for mapping locations. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on mapping locations as determined using embodiments described below.

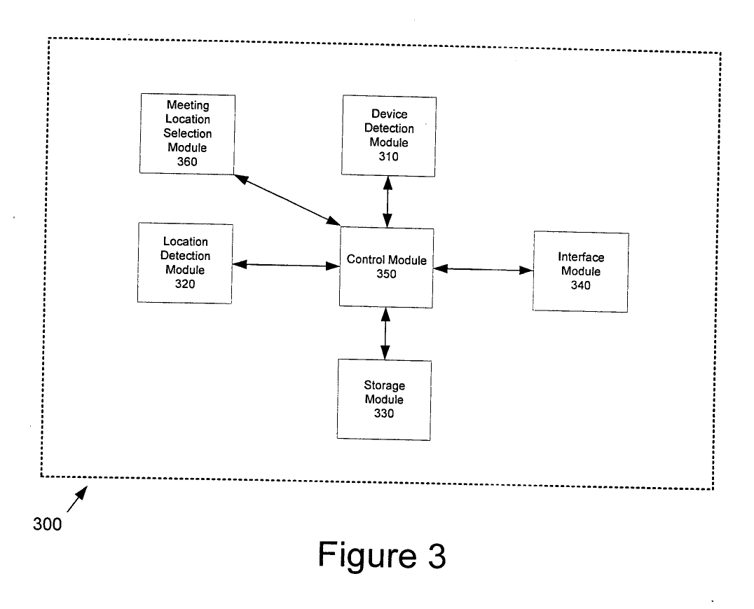

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a device detection module 310, a location detection module 320, a storage module 330, an interface module 340, a control module 350, and a meeting location selection module 360.

In one embodiment, the control module 350 communicates with the device detection module 310, the location detection module 320, the storage module 330, the interface module 340, and the meeting location selection module 360. In one embodiment, the control module 350 coordinates tasks, requests, and communications between the device detection module 310, the location detection module 320, the storage module 330, the interface module 340, and the meeting location selection module 360.

In one embodiment, the device detection module 310 detects the identity the device. For example, each device is identified by a unique identifier such as a serial number. By uniquely identifying the device, a user corresponding to the specific device is also identified in one embodiment. For example, in the case where a unique user is registered with each unique device, the user is identified when the device is identified. In another example, where multiple users are associated with each unique device, a password is utilized to identify the current user of the device.

In one embodiment, the device detection module 310 receives a signal from the detected device. In one embodiment, the signal includes a serial number that identifies the particular device. In another embodiment, the signal includes a password that uniquely identifies the device and the user of the device.

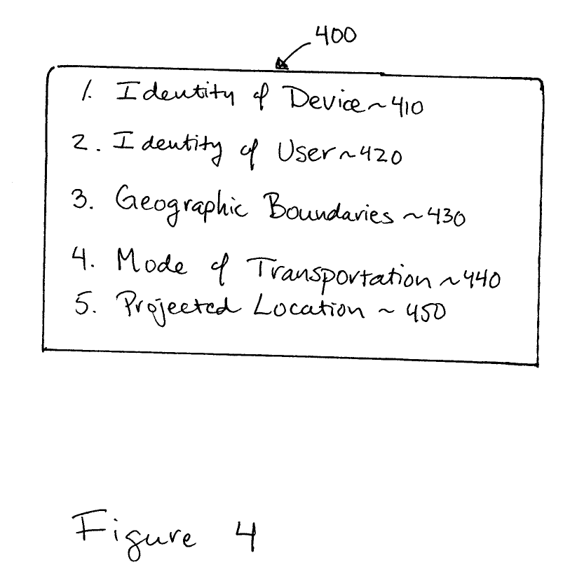

In one embodiment, by identifying the device and/or the user of the device, the device detection module 310 utilizes additional information associated with the particular device and/or user. Additional information corresponding with the particular device and/or user is shown in an exemplary record illustrated in FIG. 4. In one embodiment, this additional information is utilized by the system 300.

In one embodiment, the location detection module 320 determines the location of the device as detected in the Block 310. In one embodiment, the location detection module 320 utilizes a global positional system (GPS) via multiple satellites to identify the location of the device. In another embodiment, the location detection module 320 utilizes a cellular network to identify the location of the device. In yet another embodiment, the location detection module 320 utilizes at least one local sensor to detect the location of the device. In yet another embodiment, the location detection module 320 utilizes at least one other device to detect the location of the device.

In one embodiment, the location detection module 320 accurately detects the location of a device within one foot. In another embodiment, the location detection module 320 accurately detects the location of a device within a mile.

In one embodiment, the storage module 330 stores a record including information associated with a particular device. In another embodiment, the storage module 330 stores a record including information associated with a particular user. An exemplary embodiment of the information contained within the record associated with a user or device is illustrated in FIG. 4.

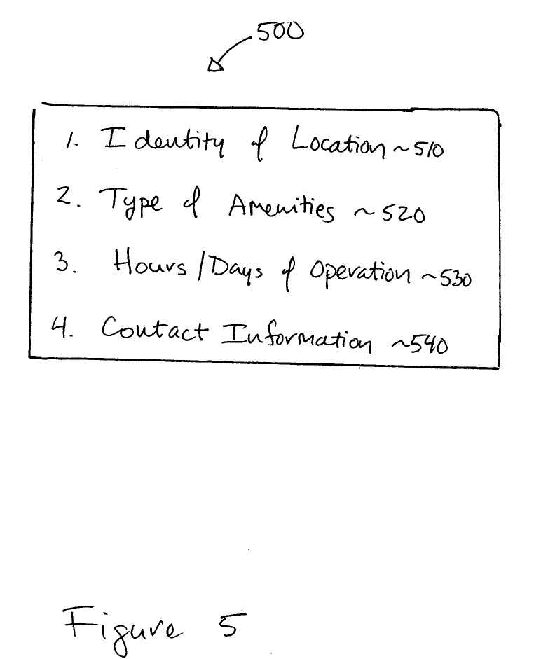

In another embodiment, the storage module 330 stores a record including information associated with a particular location or service provider. An exemplary embodiment of the information contained within the record associated with a location or service provider is illustrated in FIG. 5.

In one embodiment, the interface module 340 receives a signal from one of the electronic devices 110 indicating the identity of the device or user. In another embodiment, the interface module 340 receives a signal from one of the electronic devices 110 indicating the location of the device. In yet another embodiment, the interface module 340 transmits information to one of the electronic devices 110 indicating a meeting location.

In one embodiment, the meeting location selection module 360 selects a location for multiple users to convene. For example, the meeting location selection module 360 picks a convenient location for users of the electronic devices 110 to meet. In one embodiment, the particular meeting location is selected based on the location of each of the devices. In another embodiment, the particular meeting location is selected based on the mobility of the user associated with the device. In yet another embodiment, the particular meeting location is selected based on the preferences of the users attending the meeting.

The system 300 in FIG. 3 is shown for exemplary purposes and is merely one embodiment of the methods and apparatuses for mapping locations. Additional modules may be added to the system 300 without departing from the scope of the methods and apparatuses for mapping locations. Similarly, modules may be combined or deleted without departing from the scope of the methods and apparatuses for mapping locations.

FIG. 4 illustrates an exemplary record 400 identifying attributes of a particular participant for use with the system 300. In one embodiment, there are multiple records such that each record 400 is associated with a particular participant. In one embodiment, the record 400 includes an identity of the device field 410, an identity of the user field 420, a geographic boundaries field 430, a mode of transportation field 440, and a projected location field 450.

In one embodiment, the identity of the device field 410 uniquely identifies the device. In one example, a unique identification number is utilized to identify the particular device.

In one embodiment, the identity of the user field 420 uniquely identifies the participant. In one example, a password is utilized to identify the particular user.

In one embodiment, the same device is utilized by multiple participants. Accordingly, the identity of the user field 420 distinguishes between multiple participants utilizing the same device.

In another embodiment, each unique device is utilized by a single participant. In one example, the identity of the device is sufficient to identify the participant, and the identity of the user field 420 is not necessary. In another example, the identity of the user is sufficient to identify the participant, and the identity of the device field 410 is not necessary.

In one embodiment, the geographic boundaries field 430 identifies areas that are accessible to the particular participant. For example, if the particular participant associated with the record 400 is confined to traveling within the city limits, then the geographic boundaries field 430 describes this limitation. In one embodiment, the geographic boundary includes areas within the city of San Francisco. In another embodiment, the geographic boundary includes areas within California. In yet another embodiment, the geographic boundary includes areas within the United States.

In one embodiment, the geographic boundaries field 430 identifies areas that are accessible to the particular participant based on the current location of the participant. In this embodiment, the geographic boundary is relative to the current location of the participant. For example, the geographic boundary is any number of miles within the current location of the user.

In one embodiment, different geographic boundaries are established based on a particular time of day. For example, when traffic is heavy during rush hour, the geographic boundary is limited to locations within 2 miles of the current participant location. When traffic is lighter during non-rush hours, the geographic boundary is relaxed to locations within 20 miles of the current participant location.

In one embodiment, the mode of transportation field 440 describes the type of transportation available to the participant. For example, some participants are limited to traveling by public transportation such as bus, subways, trains, and the like. Other participants have personal transportation available such as bicycles, motorcycles, cars, and the like.

In one embodiment, the mode of transportation available to the participant differs based on the particular time of day. For example, a participant only has access to a car between limited hours.

In one embodiment, the projected location field 450 describes a projected physical location of the participant for a given day of the week and time of day. For example, some participants are located at a predictable office building during working hours on weekdays.

FIG. 5 illustrates an exemplary record 500 identifying attributes of a particular meeting location for use with the system 300. In one embodiment, there are multiple records such that each record 500 is associated with a particular meeting location. In one embodiment, the record 500 includes an identity of the location field 510, a type of amenities field 520, an hours of operation field 530, and a contact information field 540.

In one embodiment, the identity of the location field 510 uniquely identifies the meeting location. In one example, a unique name is utilized to identify the particular meeting location. Unique names include “Joe's Java”, “Bob's Burgers”, and “Golden Gate Park”.

In one embodiment, the type of amenities field 520 describes the type of amenities associated with the particular meeting location. For example, under “Joe's Java”, the amenities listed include coffee, tea, limited food, restrooms, and indoor seating. In another example, under “Golden Gate Park”, the amenities listed include recreational sports, picnic tables, grass fields, walking paths, and restrooms.

In one embodiment, the hours of operation field 530 describe the hours that the particular meeting location is available. For example, under “Joe's Java”, the hours of operation are listed.

In one embodiment, the contact information field 540 describes contact information associated with the particular meeting location. For example, the street address of the particular meeting location is listed. In another example, the phone number, email address, and web site for the particular meeting location is also listed.

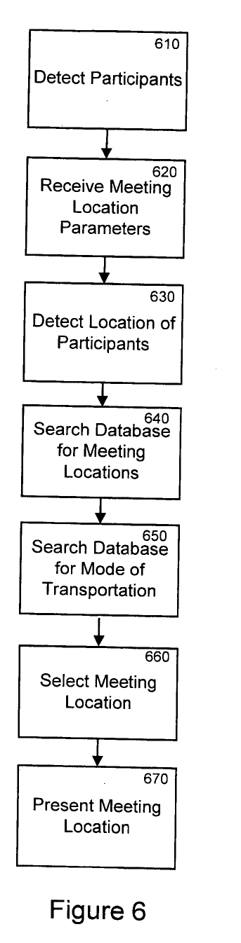

The flow diagrams as depicted in FIGS. 6, 7, and 8 are one embodiment of the methods and apparatuses for mapping locations. The blocks within the flow diagrams can be performed in a different sequence without departing from the spirit of the methods and apparatuses for mapping locations. Further, blocks can be deleted, added, or combined without departing from the spirit of the methods and apparatuses for mapping locations.

The flow diagram in FIG. 6 illustrates selecting a meeting location based on multiple factors according to one embodiment of the invention.

In Block 610, possible meeting participants that are selected to take part in a meeting are detected. In one embodiment, a meeting is defined as a gathering of more than one person for business or social activities. In one embodiment, the possible meeting participants are detected within the device detection module 310. In another embodiment, the possible meeting participants are identified within a database as represented by the exemplary record 400.

In Block 620, parameters for the meeting location are received. In one embodiment, the parameters include the time and date of the meeting, the duration of the meeting, the type of amenities desired, and the general location of the meeting. In one embodiment, the type of amenities includes indoor seating, outdoor seating, type of food served, type of beverage served, cost range, activities available, and the like. In one embodiment, general geographic parameters are included. For example, possible meeting locations may be constrained to locations within San Francisco. In one embodiment, the parameters are received through the interface module 340.

In Block 630, the locations of the possible meeting participants are detected. In one embodiment, the current locations of the possible meeting participants are detected through GPS. In another embodiment, the locations of the possible meeting participants are detected through a localized networks such as sensors, cellular network, Wi-Fi network, blue tooth network, and the like. In one embodiment, the current locations of the possible meeting participants are detected through the location detection module 320.

In another embodiment, the projected locations of the possible meeting participants just prior to the meeting are utilized. For example, if the meeting is scheduled to take place while the particular possible meeting participant is working, then the possible meeting participant's projected location would be the particular possible meeting participant's work location. In this embodiment, the projected location of the possible meeting participant is utilized instead of the actual, current location of the possible meeting participant while the meeting is being planned.

In Block 640, a meeting location database is searched for possible meeting locations. In one embodiment, the meeting location database is housed within the storage module 330 and contains multiple records which each record identifies a possible meeting location and includes attributes of the particular meeting location. An exemplary record is shown in the record 500.

In one embodiment, a group of possible meeting locations is identified based on the parameters identified in the Block 620. For example, possible meeting locations satisfying the parameters such as indoor seating, outdoor seating, type of food served, type of beverage served, cost range, activities available are identified. In this embodiment, if one of the parameters for the possible meeting locations is the availability of indoor seating and service of coffee, then only meeting locations that have indoor seating and serve coffee are identified.

In another example, if the participants indicated a geographic limitations in the associated geographic boundaries field 430, then the group of possible meeting locations excludes meeting locations that fall outside these geographic limitations.

In Block 650, a user database is searched for modes of transportation available to the possible meeting participants detected within the Block 610. In one embodiment, the user database is housed within the storage module 330 and contains multiple records which each record identifies an individual possible meeting participant and transportation available to the particular possible meeting participant. An exemplary record is shown in the record 400.

In one embodiment, at least one mode of transportation is identified for each of the possible meeting participants attending the meeting. For example, a possible meeting participant named John is invited to the meeting. In this example, John is able to travel by foot and bus to the possible meeting location.

In Block 660, a proposed meeting location is selected. In one embodiment, the proposed meeting location is selected by the meeting location selection module 360.

In one embodiment, the proposed meeting selection is selected from the possible meeting locations identified within the Block 640. These possible meeting locations identified within the Block 640 were selected based on the meeting location parameters within the Block 620. Based on the location of the users (as determined in the Block 630) and the mode of transportation of the users (as determined in the Block 650), the proposed meeting location is selected from among the possible meeting locations (as determined in the Block 640.)

In one embodiment, the proposed meeting location is selected based on the location of each of the meeting participants is analyzed relative to the geographic location of the meeting location. For example, the proposed meeting location is located between the possible meeting participants. In one embodiment, the proposed meeting location is located equidistant between the possible meeting participants.

In another embodiment, the proposed meeting location is selected based on the mode of transportation available to the possible meeting participants. For example, if participant A travels by car and participant B travels by foot, the location of the proposed meeting location is geographically closer to participant B, because it will take participant B longer to travel the same distance as participant A. In one embodiment, the proposed meeting location is selected such that participant A and participant B will take the same amount of time to reach the proposed meeting location from their respective origins.

In Block 670, the proposed meeting location is presented to the possible meeting participants.

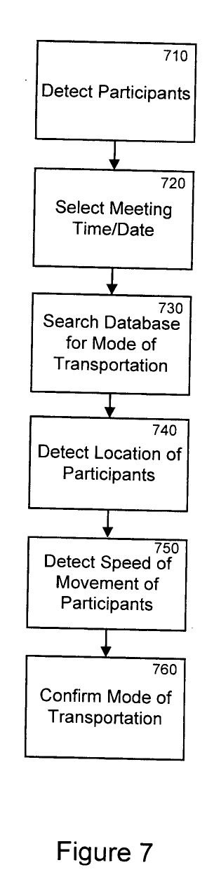

The flow diagram in FIG. 7 illustrates confirming the mode of transportation utilized by the possible meeting participants according to one embodiment of the invention. In one embodiment, confirming the mode of transportation as described in FIG. 7 provides additional details regarding searching a database for the mode of transportation as described in the Block 650.

In Block 710, possible meeting participants that are selected to take part in a meeting are detected. In one embodiment, a meeting is defined as a gathering of more than one person for business or social activities. In one embodiment, the possible meeting participants are detected within the device detection module 310. In another embodiment, the possible meeting participants are identified within a database as represented by the exemplary record 400.

In Block 720, a meeting time and date are selected for the meeting between the possible meeting participants.

In Block 730, a user database is searched for modes of transportation available to the possible meeting participants detected within the Block 710. In one embodiment, the user database is housed within the storage module 330 and contains multiple records which each record identifies an individual possible meeting participant and transportation available to the particular possible meeting participant. An exemplary record is shown in the record 400.

In one embodiment, at least one mode of transportation is identified for each of the possible meeting participants attending the meeting. In one embodiment, the date and time of the possible meeting is utilized to identify the mode of transportation for the possible meeting participants.

In Block 740, the current locations of the possible meeting participants are detected. In one embodiment, the current locations of the possible meeting participants are detected through the location detection module 320.

In Block 750, the speed of movement of the possible meeting participants is detected. In one embodiment, detecting the current locations of the possible meeting participants at multiple times allows the speed of movement of the possible meeting participants to be calculated.

In Block 760, the mode of transportation for each of the possible meeting participants is confirmed based on the mode of transportation as described by the user database in the Block 730 and the speed of movement as detected in the Block 750.

In one embodiment, the speed of movement contradicts the mode of transportation as listed in the user database. For example, by searching the user database, participant A is supposed to be traveling by foot during a weekday. However, for a possible meeting being scheduled within an hour, participant A is detected traveling at a speed that is faster than attainable by foot. Therefore, participant A is treated as traveling by public transportation or car when selecting the possible meeting location.

In another embodiment, the detected speed of the possible meeting participant is utilized to update the mode of transportation field 440 within the record 400 associated with the particular participant. For example, the mode of transportation field 440 associated with participant A indicates that participant A travels by foot during the week. However, participant A is detected traveling faster than by food during the week. Based on this detected speed of movement, the mode of transportation field 440 is updated to reflect that participant A has additional modes of transportation.

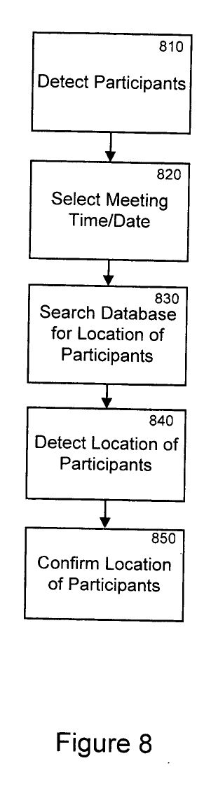

The flow diagram in FIG. 8 illustrates confirming the location of the meeting participants according to one embodiment of the invention. In one embodiment, confirming the location as described in FIG. 8 provides additional details regarding detecting the location of the participants as described in the Block 630.

In Block 810, possible meeting participants that are selected to take part in a meeting are detected. In one embodiment, a meeting is defined as a gathering of more than one person for business or social activities. In one embodiment, the possible meeting participants are detected within the device detection module 310. In another embodiment, the possible meeting participants are identified within a database as represented by the exemplary record 400.

In Block 820, a meeting time and date are selected for the meeting between the possible meeting participants.

In Block 830, a user database is searched for probable locations of the participants detected within the Block 810. In one embodiment, the user database is housed within the storage module 330 and contains multiple records which each record identifies an individual participant and the projected location of the participant prior to the meeting time. An exemplary record is shown in the record 400 and an exemplary field is the projected location field 450.

In one embodiment, one projected location is identified for each of the possible meeting participants attending the meeting. In another embodiment, multiple projected locations are identified for each of the participants. In this embodiment, the date and time of the possible meeting is utilized to select one of the multiple projected locations for the participants.

In Block 840, the current locations of the participants are detected. In one embodiment, the current locations of the participants are detected through the location detection module 320.

In Block 850, the location of the participant prior to the possible meeting is confirmed based on the projected location as described by the user database in the Block 830 and the current location as detected in the Block 840.

In one embodiment, the projected location of the participant is utilized to select the meeting location in the Block 660 and the current location of the participant is not utilized. For example, the participant may happen to be located in an unusual current location that is far away from the projected location for the date and time of the possible meeting while the possible meeting is being planned. Further, the meeting is being planned a few days in advance. In this example, the participant's current location does not accurately reflect an actual location that the participant will originate from when traveling to the possible meeting. In this case, since the participant's current location is unusual compared to the participant's projected location for the possible meeting and the possible meeting is a few days away, the participant is assigned the projected location associated with the date and time of the possible meeting.

In another embodiment, the current location of the participant is utilized to select the meeting location in the Block 660 and the projected location of the participant is not utilized. For example, the participant is located far away from the projected location and the possible meeting is within a short period of time. In this example, the participant is not physically able to return to the projected location based on the time of the possible meeting and the distance between the current location and the projected location. Accordingly, the current location of the participant is utilized in this embodiment.

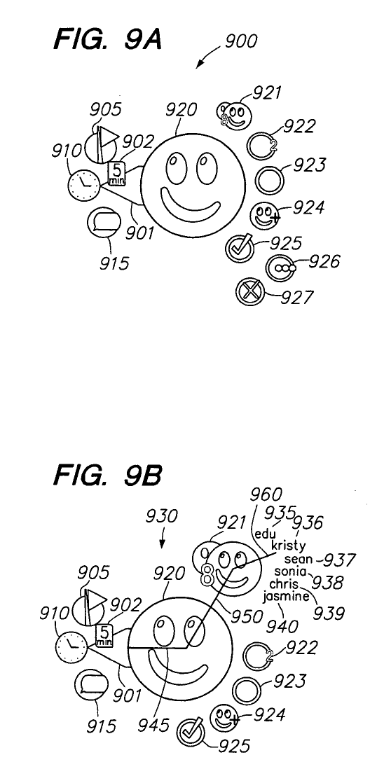

FIG. 9A illustrates a screen shot 900 that displays information relating to a meeting between multiple participants. An event 901 is illustrated including a count down timer 902, a meeting location 905, an event time 910, an event dialog 915, and event participants 920. The event participants 920 includes sub-categories of number of confirmed participants 921, number of undecided participants 922, number of participants that declined the event 923, adding a participant 924, accepting the invitation to the event 925, replying with a possible attendance to the event 926, and declining the invitation to the event 927.

In one embodiment, the confirmed participants 921 are shown in green. In one embodiment, the undecided participants 922 are shown in yellow. In one embodiment, the declined participants 923 are shown in red.

FIG. 9B illustrates a screen shot 930 that displays information relating to a meeting between multiple participants. A first segment 945 is shown selecting the event participants 920. A second segment 950 is shown selecting the number of confirmed participants 921 that is a sub category of the event participants 920. A third segment 960 is shown selecting one participant 936 from a plurality of other participants 935, 937, 938, 939, and 940.

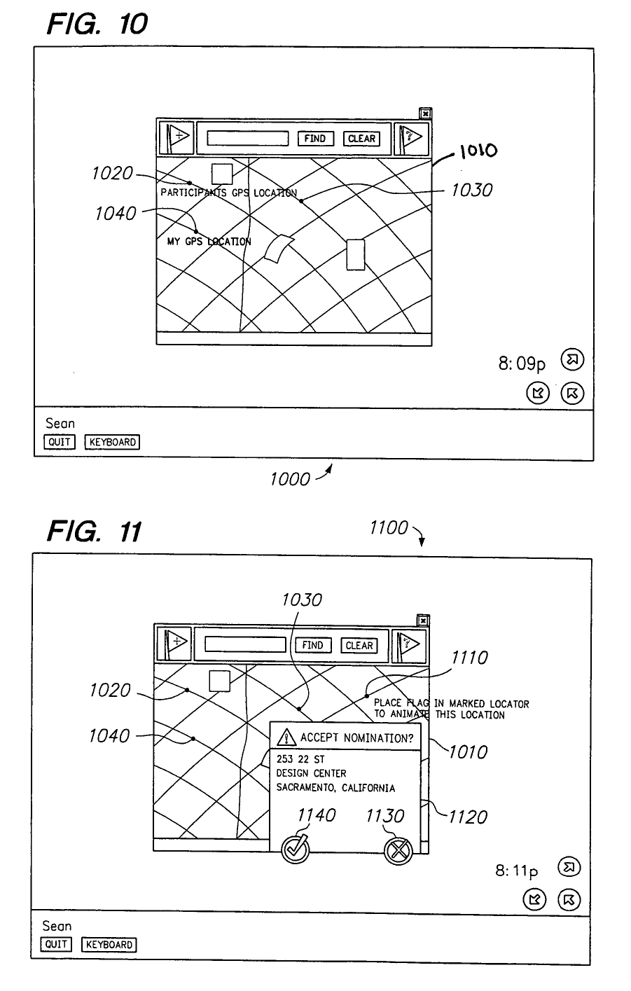

FIG. 10 illustrates a screen shot 1000 that displays information relating to a meeting between multiple participants. An event location map 1010 shows the location of multiple participants. In one embodiment, the event location map 1010 is utilized to plan the location of the event. A first participant is shown having a location 1020; a second participant is shown having a location 1030; and a third participant is shown having a location 1030.

FIG. 11 illustrates a screen shot 1100 that displays information relating to a meeting between multiple participants. The event location map 1010 shows the location of multiple participants such as the location 1020, the location 1030, and the location 1030. A flag 1110 illustrates a nominated location for the event. In one embodiment, the participants of the event vote either approving the nominated location or declining the nominated location. In one embodiment, the nominated location is a suggestion. In another embodiment, the meeting location selection module 360 produces the nominated location.

In one embodiment, the participants vote through a nominated location interface 1120. Within the interface 1120, the participants can accept the nominated location through button 1140 or reject the nominated location through button 1130.

In another embodiment, the methods and apparatuses for mapping locations suggests a new location for a potential meeting that is not stored within the storage module 330 and is based on an equal distance between the multiple participants. For example, the new meeting place may be a corner of a street that is not specific location that is stored within the storage module 330 with defined amenities.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method comprising:
detecting a plurality of participants;
detecting a location of each of the plurality of participants;
identifying a plurality of possible meeting locations based on a parameter; and
selecting a meeting location from the plurality of possible meeting locations based on the location of each of the plurality of participants.

2. The method according to claim 1 further comprising determining a mode of transportation for each of the plurality of participants.

3. The method according to claim 2 wherein the mode of transportation is by car.

4. The method according to claim 2 wherein the mode of transportation is by bus.

5. The method according to claim 2 wherein the mode of transportation is by foot.

6. The method according to claim 2 wherein the selecting the meeting location is based on the mode of transportation for each of the plurality of participants.

7. The method according to claim 2 wherein the determining the mode of transportation for each of the plurality of participants is based on a time and day of a possible meeting.

8. The method according to claim 2 wherein the determining the mode of transportation for each of the plurality of participants is based on a speed of movement of each of the plurality of participants.

9. The method according to claim 1 wherein the location of one of participants is a current location detected through a device detection module.

10. The method according to claim 1 wherein the location of one of participants is a projected location based on a typical location of the participant for a time and date of a possible meeting.

11. The method according to claim 1 wherein the parameter is a type of food service.

12. The method according to claim 1 wherein the parameter is a type of beverage service.

13. The method according to claim 1 wherein the parameter is hours of operation.

14. The method according to claim 1 wherein the parameter is a type of seating.

15. The method according to claim 1 wherein the parameter is a general geographic area.

16. The method according to claim 1 wherein the meeting location is geographically located between the location of each of the participants.

17. A system comprising:
means for detecting a plurality of participants;
means for detecting a location of each of the plurality of participants;
means for identifying a plurality of possible meeting locations based on a parameter; and
means for selecting a meeting location from the plurality of possible meeting locations based on the location of each of the plurality of participants.

18. A method comprising:
detecting a plurality of participants;
identifying a projected location for each of the plurality of participants;
detecting a current location for each of the plurality of participants;
identifying a plurality of possible meeting locations based on a parameter; and
selecting a meeting location from the plurality of possible meeting locations based on the current location and the projected location for each of the plurality of participants.

19. The method according to claim 18 further comprising determining an estimated location based on a distance between the current location and the projected location and a time proximity to a possible meeting.

20. The method according to claim 18 further comprising updating a projected location field within a record associated with one of the participants based on a difference between the current location and the projected location.

21. The method according to claim 18 wherein the projected location is based on a time and a day of a possible meeting and a record associated with each of the participants.

22. The method according to claim 18 further comprising searching for a record corresponding with each of the participants.

23. A method comprising:
detecting a plurality of participants;
searching for a mode of transportation for each of the plurality of participants;
detecting a location for each of the plurality of participants;
detecting a speed of movement for each of the plurality of participants;
confirming the mode of transportation based on the speed of movement; and
selecting a meeting location based on the location and mode of transportation for each of the plurality of participants.

24. A system, comprising:
a device detection module to detect a device associated with a participant;
a storage module to store a record containing participant information associated with the participant;
a location detection module to detect a current location of the device; and
a meeting location selection module to select a meeting location based on the current location of the participant and the participant information.

25. The system according to claim 24 wherein the participant information includes a mode of transportation.

26. The system according to claim 24 wherein the participant information includes a projected location.

27. The system according to claim 24 wherein the participant information includes a geographic boundary.

28. The system according to claim 24 wherein the storage module stores meeting location information.

29. A computer-readable medium having computer executable instructions for performing a method comprising:
detecting a plurality of participants;
detecting a location of each of the plurality of participants;
identifying a plurality of possible meeting locations based on a parameter; and
selecting a meeting location from the plurality of possible meeting locations based on the location of each of the plurality of participants.
